(19) United States
(12) Patent Application Publication
(10) Pub. No.: US 2011/0207504 A1
(43) Pub. Date: Aug. 25, 2011

(54) Interactive Projected Displays

(76) Inventors: Glen J. Anderson, Beaverton, OR (US); Philip J. Corriveau, Forest Grove, OR (US)

(21) Appl. No.: 12/711,355

(22) Filed: Feb. 24, 2010

(51) Int. Cl. H04M 1/00; H04N 5/222

(52) U.S. Cl. 455/556.1; 348/333.1; 348/E05.022

(57) ABSTRACT

A projection device may project an image on a display surface. Another projection device may then project an image that appears to interact with the image projected by the first device. A camera in one of the devices may record the interaction. The interaction may be analyzed to implement game play or user selections in general. Communications between the two devices may be established by a network communication protocol.

### BACKGROUND

This relates generally to the projection of images for display.

A variety of devices are capable of projecting images. A projection display may be a peripheral connectable to a processor-based device such as a laptop or personal computer. Projection displays may also be associated with television receivers for display of broadcast or otherwise distributed programs. In addition, standalone projectors, which may be processor-based, may be associated with the projection of relatively high quality images. As an example, movie projectors may be used in movie theaters to display images.

### BRIEF DESCRIPTION OF THE DRAWINGS

FIG. 1 is a perspective view of one embodiment of the present invention in operation;

FIG. 2 is a schematic depiction for the embodiment of FIG. 1;

FIG. 3 is a flow chart for one embodiment of the present invention;

FIG. 4 is a perspective view of another embodiment of the present invention; and

FIG. 5 is a flow chart for another embodiment of the present invention.

### DETAILED DESCRIPTION

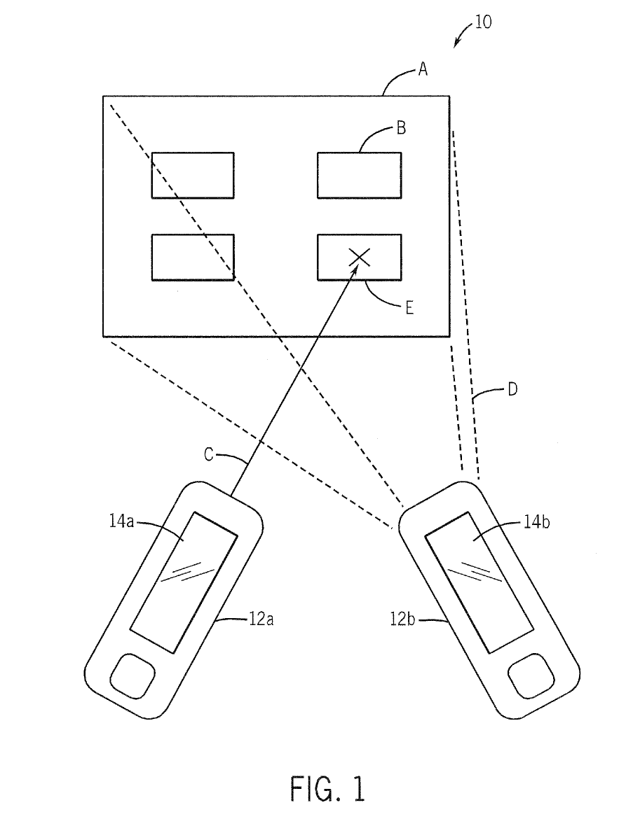

Referring to FIG. 1, a first projection device 12a and a second projection device 12b may each project one or more images indicated as A, B, C, and E on a display surface, such as a wall or display screen. The devices 12a or 12b may be handheld devices, such as cellular telephones or mobile Internet devices (MIDs), to mention two examples. They may be equipped with internal projection devices capable of projecting images on a remote display surface. The devices 12a and 12b may also include their own display screens, such as the display screens 14a and 14b that, in some embodiments, may be touch screens. They may include other capabilities, including cellular telephones, movie cameras, and the like, to mention a few examples.

In accordance with some embodiments of the present invention, the projection device 12a may project an image along the path C so as to interact with the image E projected by the projection device 12b. This interaction may then be detected by a camera associated with one or both of the projection devices 12a and 12b in order to assess an interaction. For example, in one embodiment, the device 12b may project an image which includes a number of different user selectable options. These options, indicated by rectangles, such as rectangle B, may be selected by the other projection device 12a by projecting an image or mark (e.g. an “X”) onto the display A, projected by the device 12b.

If the two devices are connected in a network, such as a wireless network as one example, the interaction may be used to make selections between the various devices. For example, one or more video cameras, associated with one or more of the devices 12, may detect the projected image interaction and that interaction may be analyzed to assess a user selection. For example, a video camera on board the device 12b may detect the mark placed on the display element E by the device 12a. It may understand this to be a selection to obtain more information from the device 12b, which information then may be provided by a subsequent projected display, as one example, or by a transmission over an network connection to the device 12a.

For example, the projected image A may include a display in the course of a user presentation. A user using the device 12a may select the displayed image box E in order to obtain more information about the item E represented by that image. That information may then be supplied by the device 12b, either by a subsequent projected image or by data provided over a network connection to the device 12a. As a result, in some embodiments, images projected by separate devices may enable interaction between the devices and information exchange for a variety of other purposes including game playing.

An another example, an image projected in a movie theater may be used as the projected image A. Viewers in the movie theater may then select image objects projected on the image screen to obtain more information about those image objects. For example, the user may illuminate, using an infrared beam, a projected image object associated with the movie. The image object may, for example, be an image of an actor and, in response, the projection device in the movie theater may supply additional information to that user who selected the image object. The user may be identified by a wireless message transmitted by the device 12a, indicating that the user had just selected an image object. Then a video camera associated with the movie theater may detect which element was selected by overlay of projected images, for example, and may provide the information to the inquiring user.

In another example, the projected image may be a laser pointer, normally just used for highlighting a spot on a presentation, that are capable of projecting various colors and patterns. For example, one projection device may be projecting a presentation, while users with laser pointers interact with the presentation by pointing at it. A camera coupled with the device projecting the presentation interprets the laser projection in a variety of ways. For example, a color of laser may indicate a yes or no vote or that the next slide should now be shown. In another example, the laser input may be interpreted as selection and drag-and-drop commands, thus allowing the laser pointers to manipulate objects in the presentation that is being projected.

In order to control which projections are allowed to interact with the first projection, the second projection may indicate a certain range of colors or blink as a form of password (in visible range, infrared, and/or through wireless connectivity). Depending on the level of security needed, the visual passwords may be changed periodically via wired or wireless syncing of password information.

In another example, a projected image from one device may be captured and added to the projection of the another device. As still another example, a first user may project a display that leaves a blank input area for a second user to project information requested by the first user. For example, the first user may ask the second user to provide a photograph of himself or herself. The second user may then project the requested photograph into a blank area left for this purpose in the projected display. A video camera on the first user's computer records the input within the input area and, based on it being within the input area, extracts that photograph and stores it as requested by the first user. Thus, in addition to providing user inputs through a second user's projector, the second user may also supply files, images, data, or other information to the first user over a projection system.

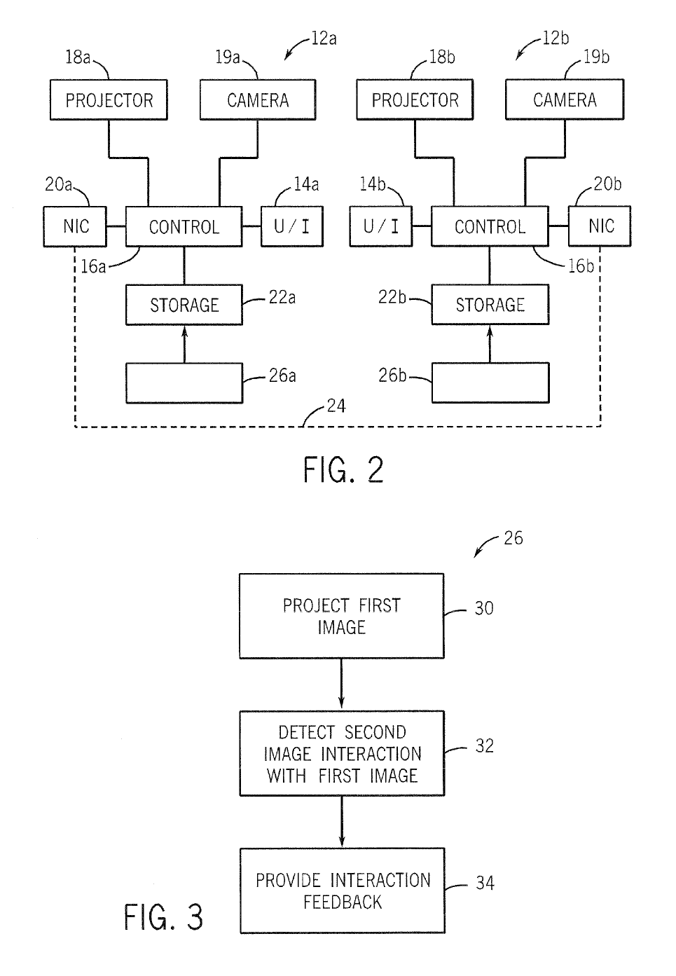

Referring to FIG. 2, in accordance with one embodiment, the devices 12a and 12b may be mobile handheld devices, in one embodiment, but, in other embodiments, they may be either wired or mobile/wireless devices. Each of the devices 12a or 12b may include a control 16a or 16b which may be a processor or controller in some embodiments. Each control may be coupled to a network interface card 20a or 20b to enable network communications between the devices. These communications may be over wired or wireless connections, including infrared or radio frequency connections, as examples.

Each control 16 may also be coupled to a storage 22a or 22b which may, among other things, store software and image elements to be displayed. For example, each storage 22a or 22b may store the software 26a or 26b, as an example.

In addition, each control may be coupled to a user interface 14a or 14b, which may be a touch screen in one embodiment. Each control may also be coupled to a camera 19a or 19b in order to record interaction between projected displays. Finally, the projected displays may be projected by projectors 18a or 18b for each device. The network interaction, indicated at 24, may be via wire, wireless radio, wireless light, or any other media.

Thus, referring to FIG. 3, one of the devices 12a or 12b may project a first image, as indicated in block 30. Then, the second device 12a or 12b may project an image to interact with the first image. That second image may be detected by a video camera associated with one of the devices 12a or 12b, as indicated in block 32. The visual interaction may be analyzed to determine if a user selection or input is indicated by the image interaction and, if so, interaction feedback may be provided, as indicated in block 34.

Thus, in some embodiments, the sequence depicted at 26, in FIG. 3, may be implemented in software stored on a computer readable medium, such as the storage 22, which may be a semiconductor, optical, or magnetic storage. The sequence may be implemented by instructions executed by a processor or controller, such as the control 16a or 16b in some embodiments.

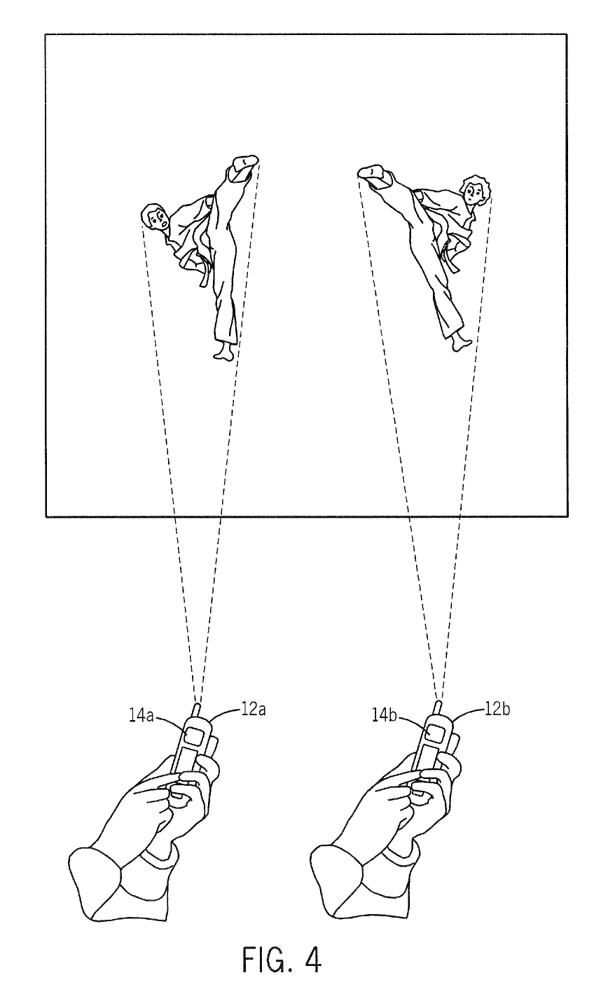

In other embodiments, games may be implemented, for example, as indicated in FIG. 4. In this example, two projected fighting character images are displayed on a display area. Each of the users may project a character image using a device 12a or 12b. Controls may be implemented in a variety of ways, including using touch screens 14a and 14b. Interaction between the images may be an indication of game action, such as a boxing game.

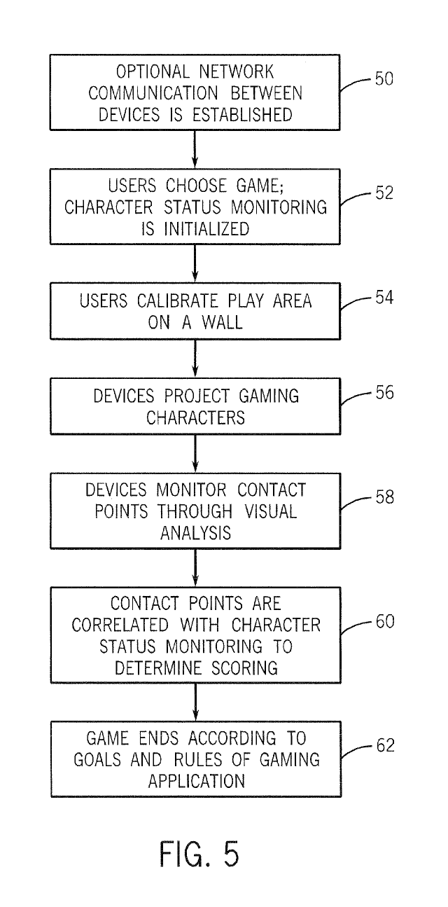

Thus, in one embodiment, a sequence may be implemented by a series of instructions executed by the control. As depicted in FIG. 5, a network communication may be established between the devices 12a and 12b, as indicated in block 50. The users may then choose a game and character status monitoring is initiated, as indicated in block 52. The users may calibrate a play area on a wall, for example, as indicated in block 54. Then, the devices project gaming characters, as indicated in block 56. In block 58, contact points may be detected through analysis of a video stream from a video camera, as indicated in block 58. Thus, in a fight game, contact between the characters may be detected by a camera associated with one or both of the devices 12a and 12b. Image recognition software may be used to analyze the projected image interaction.

Then, in block 60, contact points are correlated with character status monitoring to determine scoring. The game is implemented according to goals and rules of the gaming application, as indicated in block 62.

Other game examples may be a projected tic-tac-toe game, where one player projects a tic-tac-toe pattern and each of the players may project selections. One user selection on a tic-tac-toe pattern projected by the other device may be detected by a camera on the first device and then displayed in real form on the first device's projected display. In this way, the game can be implemented on the projecting first device and a winner identified.

Of course, many other games and non-game applications will be appreciated by those skilled in the art.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a projector to project an image;
a camera to record a projected image; and
a control to detect interaction between an image projected by said projector and another projected image.

2. The apparatus of claim 1 wherein said apparatus is a cellular telephone.

3. The apparatus of claim 1 wherein said apparatus is a mobile Internet device.

4. The apparatus of claim 1, said control to establish a network with another device having a projector to exchange information.

5. The apparatus of claim 1 including image recognition software to recognize an image projected by another device that interacts with an image projected by said projector.

6. The apparatus of claim 1 to detect overlapping between images projected by said projector and an image projected by another apparatus.

7. The apparatus of claim 1 to implement a game.

8. A method comprising:
projecting an image from a first device;
recording the projected image using an image recording apparatus; and
detecting an interaction between the projected image and another image generated by a second device by analyzing visual information captured by said recording apparatus.

9. The method of claim 8 including implementing a game between two players where each player projects an image and interactions between the projected images are recorded by said recording apparatus.

10. The method of claim 8 including projecting an image including a plurality of selectable options and receiving a generated image from another user that selects one of said options.

11. The method of claim 8 including projecting an image that requests information from another user, identifying a user's projected response and recording the information provided by the projected response.

12. The method of claim 8 including projecting the image using a mobile Internet device.

13. The method of claim 8 including exchanging information over a wireless network with another user who has projected a second image associated with the image projected by said first device.

14. The method of claim 8 wherein detecting interaction with another image including detecting interaction with a laser power.

15. The method of claim 8 including receiving a projecting image from said second device.

16. A computer readable medium storing instructions executed by a computer to:
display a projected image;
record said image with an image recording device; and
identify an interaction between the projected image and another image.

17. The medium of claim 16 further storing instructions to identify visual information projected on top of the projected image.

18. The medium of claim 16 further storing instructions to identify a laser pointer projected on said projected image.

19. The medium of claim 16 further storing instructions to implement a game between two players where each player projects an image and interactions between the projected images are recorded by said recording device.

20. The medium of claim 16 further storing instructions to project a display including a plurality of selectable options and receive a user selection by displaying an image indicating which of said selections is preferred.
